(19) United States
(12) Patent Application Publication
(10) Pub. No.: US 2009/0215606 A1
(43) Pub. Date: Aug. 27, 2009

(54) SOL-GEL PROCESS

(76) Inventors: Lucia Gini, Novara (IT); Lorenzo Costa, Sommo (IT)

Correspondence Address: SMITH, GAMBRELL & RUSSELL, LLP;Suite 3100, Promenade II, 1230 Peachtree Street, N.E., Atlanta, GA, 30309, US

(21) Appl. No.: 11/997,651

(22) PCT Filed: Aug. 2, 2006
(86) PCT No.: PCT/EP2006/064995

§ 371 Date: Mar. 19, 2009

(30) Foreign Application Priority Data
Aug. 10, 2005 (IT) NO2005A000012
Aug. 2, 2006 (EP) PCT/EP2006/064995

(51) Int. Cl. C03C 3/06; C03B 19/12; B32B 3/26

(52) U.S. Cl. 501/12; 65/17.2; 428/304.4

(57) ABSTRACT

Sol-gel process comprising preparation of a solution of at least one compound having the formula Xm-M-(OR)n-m addition to the solution of the dopants, hydrolysis of the compound to form the sol, possible addition of an oxide, gelling the sol, recycling the liquid and adjusting the pH-value of the liquid in order to fix the dopants in the aquagel, gel drying and densifying to obtain the glass.

### INTRODUCTION AND BACKGROUND

The present invention relates to an improved sol-gel process substantially based on the control and the determination of ionic species, specifically cationic, in aqua-gel, typically a silicic one, through recycling the relevant liquid phase, suitably monitored and eventually chemically modified for the wished final material.

Moreover, the invention relates to the obtained aero-gel product which owns predetermined characteristics definable by values setting the same among the known most valuable ones that are achieved by the very careful control of the number of the silanols as well as of the covalent bonds rising during a process phase before the treatments preceding the gellation.

The inventive process has a general meaning in the field of the sol-gel material preparation; however it feels particularly good in the preparation of silica glasses owning determined optical properties. Thus, if reference is made, from an example point of view, to the preparation of silica glasses, it is known that the glass doping to achieve controlled modifications of the optical properties is a primary purpose of the optical material industry since a long time.

The products obtained in the field are the result of a specialized, advanced research firmly carried out over a century by leader companies and are, from the material point of view, the only valid options in the hands of the optical designer.

The complete inventory of these products results from conventional processes of thermal vitrification, based on the furnace melting of suitable formulations of solid components, usually under the shape of finely ground and carefully mixed powders.

The limitations of such technology originate from the fact that some components have a tendency to segregate from the mixture, because of the decreased viscosity of the system owing to the high melting temperatures (≧2200° C.).

The sol-gel process is thermodynamically favoured on the melting process since the relevant temperatures are much lower (<1400° C.) and the intermediate viscosities much higher.

Under the historical purpose “To broaden the optical space owned by the designer”, careful consideration and studies have been made of the sol-gel chemical processes in order to exploit the thermodynamic edge in the manufacture of doped glasses, with reference specially to the refraction index, the optical dispersion and the optical homogeneity.

Since the 80's, the relevant literature, scientific and patent, contains a lot of references, examples and results. However the problems pertaining the manufacture of sol-gel glasses having modified optical properties with respect to the pure silica glasses stand still unsolved. Nowadays in the market there are not bulk optical glasses prepared with sol-gel processes with formulation able to modify any relevant optical property. The doping problems of the sol-gel processes seem to be in the very chemistry used in the sol preparation.

It is known that, in the preparation of a multi-oxides sol, a high attention is generally cared to let all precursors be uniformly hydrolyzed, or at least uniformly dissolved, in order to avoid precipitations or turbidity formations, which, when present, would indicate not uniform state of the sol and, potentially, a cause of glass non-homogeneity. However, the many precursors of a multi-oxide sol have quite different hydrolysis times, and this fact causes a problem since it forces to carry out compensation procedures to let all precursors be dissolved at the same time.

Use is made also of the pre-hydrolysis of the more stable precursors, i.e. the ones having a relatively slow hydrolysis. A very unstable sol is obtained, gelling in a necessarily short time. The obtained gel, aqua-gel or alco-gel, contains all sol components: either covalently bonded to the silica network, or simply dissolved therein, or in the liquid phase inside the same or filling the pores thereof. As far as the doped glasses sol-gel synthesis is concerned, we noted that, according to the majority of the procedures cited in the filed literature, the formulation components do not maintain the original concentration in the aqua-gel (or in the alco-gel) when the gel is subjected to a solvent exchange or is washed; though the two operations are compulsory in the course of a sol-gel process for the synthesis of massive glasses. This fact, easily demonstrable, provokes the formation of an unfixed formulation, variable on the ground of the process procedures and poorly controllable thereby; therefore a final glass is obtained having unpredictable optical properties, as well as an unreliable product.

A further big problem pertaining the optical glasses prepared thereby raises during the thermal treatments carried out to transform gel into glass. It was observed, and it is well supported by the literature, that some components of the multi-oxide glass segregate from the material mass and crystallize [Journal of Non-Crystalline solids 145 (1992) 175-179]. This fact should not occur in a sol-gel process, just owing to that thermodynamic advantage thereof over the corresponding melting process. Such occurring, the conclusion is that the experimental procedure used is not able to exploit the advantageous thermodynamic conditions that a sol-gel process offers unquestionably.

Moreover, all the segregation and crystallization phenomena observed as consequence of the thermal treatment of doped sol-gel materials are consistent with the simple hypothesis of unbound, mobile moieties present in the material during the thermal treatment.

### SUMMARY OF THE INVENTION

The applicant has now discovered, that it is possible to overcome most and maybe all the problems described in the sol-gel prior art in manufacturing doped silica glasses, by applying a newly developed process based essentially on a recycle through the aqua-gel to achieve chemical-bonding of relevant cat-ions to the oxide net-work of the gel.

Moreover, all the segregation and crystallization phenomena observed as consequence of the thermal treatment of doped sol-gel materials are consistent whit the simple hypothesis of unbound, Mobil moieties present in the material during the thermal treatment.

The Applicant has also realized that the same sol-gel inventive step that can advantageously be applied to Optics can equally well be applied to vitrification of Nuclear Wastes that is a further objective of the present invention and specially of High-Radioactivity Liquid Waste, for long-term stocking in appropriate storage sites for which the process is particularly indicated.

The basic procedure is the same and includes gellation under appropriate conditions of the appropriate sol and/or of the original liquid waste, control and determination of ionic species present in the liquid phase of suitable aqua-gels, recycling to the aqua-gel of the liquid phase, properly monitored and eventually modified, immobilization of the ions of interest in the aqua-gel itself, as well as final treatments of the doped gel, its vitrification in a monolithic body utilizing any know technique, from monolithic densification of monolithic aero-gels, to sintering of aero-gel fragments and/or xero-gel fragments, to the melting of aero-gel and/or xero-gel fragments, either in the absence of other glasses or in presence of the same, as solid fragments, properly grinded and mixed, or as liquid melt relatively fluid.

For the sake of clarity it is here defined for the contest of the present patent application the following:
Aero-gel as the porous, dry gel obtained from a wet gel by extraction of the liquid phase under conditions supercritical or practically equivalent to supercritical;
Xero-gel as the porous, dry gel obtained from a wet gel by evaporation of the liquid phase at atmospheric pressure or at pressure substantially lower than supercritical;
Monolithic aero-gel as an aero-gel without fractures or cracks, even micro cracks, able to undergo successfully to the process of densification to the theoretical value of density predicted from the formulation of that material;
Fusion process as the melting of the material to obtain a monolithic body of the same;
Sintering process as the thermal treatment of powder materials, typically ceramic or metallic, often crystalline, to obtain a single body, often porous;
Densification process as the thermal treatment of amorphous, porous gel, to produce, through viscous flow, amorphous material (glass), of theoretical density predicted for the formulation.

Alternatively the dry gel can be inglobed in concrete artefacts in the proper proportion of glass to cement.

Radioactive wastes, also know as nuclear wastes, are radioactive substances, that can not be utilized any further. They must be properly stored or disposed by with all the care due to avoid damages to ambient and to men kind.

Radioactive wastes can be solids, liquids or gases, produced, among others, by nuclear plants, by research centers, and by radioisotopes users. The treatment and conditioning of radioactive wastes, especially the liquid, high-radioactivity wastes, generate complex technological problems, that often require highly specialized solutions. One of the basic problems, arising from operating plants for the nuclear fuel processing is the need of storage for long times large quantities of liquid wastes containing the fission products of uranium and plutonium.

In general terms such a treatment consists in concentrating and subsequently storing in suitable shielded containers the concentrated material until radioactivity is decayed to safe levels. In particular for liquid nuclear wastes of high radioactivity, originating from the regeneration process of spent nuclear fuel, the residue after concentration and drying are stored in suitable containers and eventually housed into underground deposits, properly shielded by thick concrete walls for long-term stocking sufficient to decay to safe radioactivity level.

A problem connected to such a program arises from the large fraction of contaminated salts, their consequent water solubility, the associated mobility and the high potential for spreading radioactive isotopes.

The remedy to the problem should be the immobilization of the dry material into a solid monolithic body characterized by high chemical stability and adequate thermo mechanical resistance: qualities typically present in glass monolithic bodies. However the high salt content, in general, is an obstacle to vitrification: conventional method to vitrify a solid is based on inglobation of the finely subdivided solid into an adequate mass of fused glass. The efficiency of the long-term inglobation is the highest, when the salt content is the lowest. As a matter of fact salt, even if inglobated into glass, remains chemically foreign to the oxide network of the glass and constitutes, at the surface of the material, a weak point to the water attack. After dissolving it leaves behind a porous network that will extend the surface area toward the interior of the glass, opening, the door-way to more hydrophilic attacks.

The origin of the problem rests upstream in the process of spent-fuel treatments that depend on dissolution of the fuel in concentrated mineral acids.

The high acidity of the original liquid waste is partially controlled trough a stage of evaporation and/or a successive neutralization by soda, but the result is more contaminated solid mass.

For these reasons the high salt content is a general obstacle, commune to many techniques of wastes inglobation, from conventional vitrification by fusion, to sol-gel vitrification, to inglobation in concrete, in polymeric materials, as well as into bitumen. High radioactivity, the formation of the radioactive splashes of hot vapour, the poor thermal conductivity of crystalline salt encrustations contribute additional difficulties. Of course the problem of long-term stocking of liquid nuclear wastes was extensively faced in search for solutions. Among methods and techniques used is worth to mention concentration of solutions exploiting the thermal effect of radioactive decomposition; unfortunately several years are required for this technique to produce results. Other methods were proposed, but their application remains confined to reduced scale or to experimental condition.

Among these:
Use of radioactive water to make concrete blocks:
Zeolite treatment to fix ions of active metals and successive calcinations of the products obtained;
Evaporation to dryness and successive inglobation in glass;
Use of composite aero-gels to trap into pores radioactive material;
Evaporation to dryness in metal crucibles maintained at relatively low temperature;
Sol-gel vitrification of liquid nuclear wastes, either of low radioactivity, or of low concentration of radioactive isotopes.

All such methods maintain connotation of onerous operations difficult to controls, need of specially equipped space for managing huge volumes of products and consequently high transportation cost.

The applicant, in the PCT-application WO 2005/040053 has described and claimed a sol-gel process, that includes, in a succession economic operations, an accurate action of mutual disposition of two non miscible liquids for the control of gellation and an accurate regulation of ph during the hydrolysis and gellation stage, that when applied to the gellation of the liquid radioactive waste, could allow to obviate of all the inconvenients in the methods described in the previous art, offering potential reduction in the cost of separating the non-radioactive liquid from the metal cat-ions present in the waste and specially from the radioactive isotopes.

A limitation of such a process for application to nuclear waste vitrification is the lack of a mechanism for continuous adaptation of liquid phase to the optimum conditions for chemical-bonding of relevant cationic content of the original waste to oxide network in the gel. Without such a provision it is difficult to achieve the recovery of a liquid phase from all the radioactive isotopes, in all the various formulations offered by liquid wastes. Such a continuous adaptation of the liquid phase to optimum conditions for chemical-bonding of relevant cat-ions to oxide network in the gel is now provided by the recycle through the aqua-gel with analytical monitoring and appropriate modification of the liquid-phase presented by the applicant of the current patent application.

With reference to the general meaning of a sol-gel procedure, the term gel means a rigid or semi-rigid colloid containing remarkable amounts of liquid. The particles of the gel are linked into a tridimensional network that efficiently immobilize the liquid: therefore the gels may be considered solid substances, more or less plastic (non crystalline).

It is known that the gel formation is generally carried out through the transformation of a colloidal dispersion via, for instance, a viscosity increase because of chemical reasons, or initially physical reasons, such as an increase of the concentration thereof through the solvent partial evaporation; a more common use is made of the sol-gel techniques, which mean a wide variety of chemical processes wherein an oxide is produced starting from a colloidal solution or dispersion (called “sol”), such an oxide being simple or mixed under the shape of a tridimensional solid body or of a thin layer on a carrier.

Sol-gel processes are the object of several patent publications, and are for example described in the following: U.S. Pat. No. 4,574,063; U.S. Pat. No. 4,680,048; U.S. Pat. No. 4,810,074; U.S. Pat. No. 4,961,767; U.S. Pat. No. 5,207,814.

The solvent of the starting solutions is usually selected among water, alcohols or hydro-alcoholic mixtures. The precursors may be metal or metalloid soluble salts, such as nitrates, chlorides, acetates, even if the more common use is made of compounds having the general formula M(-OR)ₘ, wherein M is the metal or metalloid atom, —OR is an alcoholic radical (usually from an alcohol containing from one to four carbon atoms) and n is the valence of M. The most frequently used precursors are tetramethoxyorthosilane (known as TMOS) having the formula Si(OCH₃)₄ and tetraethoxyorthosilane (known as TEOS) having the formula Si(OCH₂CH₃)₄.

The first stage of a sol-gel process is the precursor hydrolysis by water, that may be the solvent or be added in the case of alcoholic solutions, according to

M(-OR)ₙ+nH₂O→M(OH)ₙ+nROH (I)

This reaction is generally favoured by low pH values, lower than 3 and preferably ranging from 1 to 2.

The second phase is the condensation of M(OH)ₙ previously obtained

M(OH)ₙ+M(OH)ₙ→(OH)ₙ₋₁M-O-M(OH)ₙ₋₁+H₂O (II)

The above reaction, covering all M(OH)ₙ species being in the solution at the beginning, produces an inorganic oxide polymer having an open structure, whose porosity contains the starting solvent and the alcohol obtained under the reaction (I): this inorganic polymer is defined gel.

In order to be applied in the massive glass manufacture, the gel must be dried by the extraction of the liquid phase present inside the pores.

One drying method is the solvent evaporation: a dry gel obtained thereby is called “xero-gel”. The skilled people know that the xero-gel production is extremely difficult owing to the several capillary strengths the solvent drives on the pore walls during the evaporation that sometimes destroy the gel.

One other alternative way to produce dry gels is based on the solvent supercritical or hypercritical extraction: dry gels obtained thereby are known as “aero-gels”. According to the hypercritical drying the gel pore liquid is brought, inside suitable autoclaves, till to pressure and temperature values higher than the critic ones. Consequently all liquid volume passes from the liquid phase to the supercritical fluid phase, and the capillary pressure inside the pores gradually passes from the starting value to a reduced value, so avoiding the meniscus destructive tensions, that are caused by the evaporation, typical of xero-gel production.

The solvent supercritical extraction technique is described, for instance, in the U.S. Pat. Nos. 4,432,956 and 5,395,805. The main problem thereof is given by the fact that the alcohols, usually present in the gel pores after the formation of the same, have critical pressures (P_{c}) generally higher than 60-70 bar and critical temperatures (T_{c}) higher than 250° C. These critical values force to use extremely resistant and costly autoclaves; furthermore, when the gel is shaped as a thin layer on a support (for instance in order to produce an aerogel dielectric layer as one phase in the production of integrated circuits), the alcohol and ester critical temperatures may be too high, not compatible with the carrier or other materials thereon.

A way to overcome the problem consists in exchanging the liquid of the pores, before the extraction, with a liquid having lower critical constants, particularly a lower T_{c}. For instance, it is possible to use pentane or hexane, showing T_{c} values of about 200° C. A further exchange may be carried out with an intermediate liquid, for instance acetone, or, from a general procedure, the gel pore solvent is directly exchanged with a non protic solvent before any drying operation.

Last, but not least, is the option of a low temperature critical extraction. The critical pressure and temperature values of CO₂ are respectively 72.9 atm. and 31° C. At these values the super critic extraction may be carried out at room temperature.

The reason why a supercritical extraction of the aquagel has to be carried out at room temperature is to prevent in multioxides aquagel segregation of one or more components which would lead to nucleation and crystallisation during the subsequent thermal treatment (densification).

The advantages reported are substantial in preventing, or at least limiting segregation during the supercritical drying, when temperature is strong co-factor together with the liquid phase, of the molecular species mobility.

For clarity sake, we should recognize that the temperature required to get complete vitrification of a gel, essentially silicic are such as to cause crystallisation into samples containing mobile dopant components as, for example, unbound molecular species. Crystalline titanium dioxide, for example, either as anatase or as rutile, is frequently obtained in the densification phase of gels derived from sols containing titanium alkoxides; however the extent of the dopant nucleation is substantially different depending on drying conditions: it is maximum in aero-gel dryed at 300° C., it is minimum in gel dryed at room temperature, especially in aero-gel dried in CO₂.

Surely it is possible to follow some other options to carry out the supercritical drying under more favourable conditions: for instance, to carry out the same in liquid xenon having critical conditions also more favourable than CO₂, according to the patent application US 2005/0244323 having the title “Method for the preparation of aero-gels”. Indications from market surveying are consistent with potentially broad applications of aero-gels. For example they can be aimed at thermo-acoustic and catalysis fields, as well as at being intermediates in the production of glasses or glass ceramics; furthermore they can be used as insulating layers having a very low dielectric constant in the production of integrated circuits.

According to the described methodology it is furthermore possible to produce monoliths of interesting material by pouring the sol into a suitable mould, or by making of film by pouring the same onto a suitable carrier, or also of composite pre-forms for optical fibres. In this case, use may be made also of suitable doping agents that are added to the base composition in order to achieve a suitable difference in the refraction indexes among the many components of the same form.

A sol-gel process can be also utilized to recover and to stock the radioactive wastes such as, for instance, the ones described in U.S. Pat. No. 5,494,863, or in the WO 2005/040053 according to which aqueous effluent solutions of radioactive substances are gelled and then suitably stored.

With reference to the above application, to the optical glass widely described case as well as to the most of the preceding utilizations, the gellation phase does appear very important, since the gel microstructure is formed therein and the relevant composition contemporaneously consolidates in view of any future utilization, industrial use or simple storing, after the drying or, if any, densification operation. It is known that the gelation fixes a structure, causes for the same functionality thereof, and is critical to enhance or to suppress advantages derived to the subsequent products. Therefore it may be fundamental that the gellation involves all the species present in the hydrolysis phase just at the very beginning, or, if added eventually later to provide specific properties to the final product and that no one of such species be released from the gel structure, because of either high concentration, or too short absorption times, or any other reason and, that consequently, it fails to give contribution to the final glass properties: for instance, mention can be made of the optical fibre doping agents, the lack of which could irreparably compromise the properties, or of the radioactive wastes that, if going out from the gel network, could provoke strong environmental damages; in the peculiar case of the optical glasses, an underlining has been made on the problems affecting the current sol-gel processes with reference to the preparation of massive, doped, optical grade glasses, whose problems are the reason why the very sol-gel techniques fail to produce commercial grade optical glasses.

The applicant has now found that it is possible to carry out an improved sol-gel process that, in the specific case of the optical glasses, avoids the abovementioned problems, as far as the doping agent loss during the aquagel liquid phase treatment is particularly concerned, and that allows to prepare gels having a composition quite corresponding to the wished purposes, for instance comprising all doping agents foreseen to obtain a high refraction index and low dispersion glass, (high “Abbe” number), or to obtain the optical fibres core, or also to obtain glasses comprising all radioactive isotopes in the case of the radioactive waste treatment, so to remove all residual radioactivity from the liquid phase and preventing it to return to the environment.

Therefore the present invention relates to a sol-gel process in which the possible gel solvent exchange and the gel drying are carried out after a careful monitoring of the aquagel liquid phase in the gellation mould so as to be sure that all components of the programmed formulation are irreversibly fixed in the very aquagel.

### BRIEF DESCRIPTION OF DRAWINGS

FIG. 1 is a schematic representation of recycle equipment used in the present invention;

FIG. 2 is a graph of time, Al content and pH for the gelling process of the invention as described in Example 3;

FIG. 3 is a graph of time, Al content and pH for the process of the invention as described in Example 4;

FIG. 4 is a graph of comparative refractive index values for glasses according to Al₂O₃ content; and

FIG. 5 is a graph of comparative density values for glasses according to Al₂O₃ content.

### DETAILED DESCRIPTION OF INVENTION

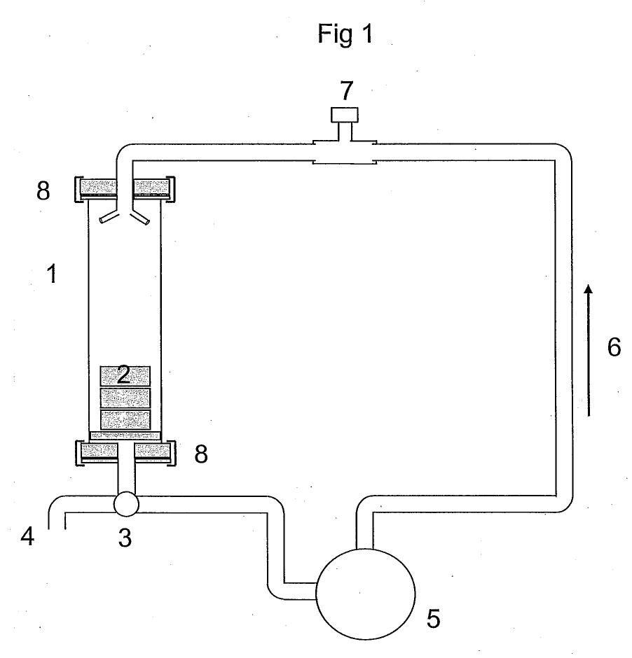

Of course the scheme of FIG. 1 is reported by a mere exemplification, to be used on a laboratory scale. To scale up the same to an industrial use means to use a more technological one, comprising suitable mixing zones after the inlet(s), that may be located in different points, as well as some analytical sensors on line and an automation, that may be also throughout. In the case of utilizations involving radioactive isotopes, the device will be suitably shielded and remote controlled.

The monitoring of the aquagel liquid phase in the gellation moulding substantially consists of:
transferring a liquid from the gellation mould to an analysis stage to determine the composition thereof,
If needed, modifying the same liquid composition to ensure more suitable conditions for the immobilization of the aquagel interesting ionic species,
If needed, recycling the liquid to the doping reactor till the desired composition is reached,
If needed, adding to the medium a suitable concentration of a hydroxyl-derivates of the element constituting the sol precursor,
If needed, further adding doping agents,
If needed further analyzing and recycling to the aquagel phase and so on till the effluent resulted to be suitable to the after gellation treatments, from the point of view of a suitable correlation between the recycle liquid chemical composition/concentration and the final product wished properties: such final materials are of course a second object and an integral part of the present invention, they being doped gel products having predetermined characteristics definable by values setting the same among the known most valuable ones. Such values characterizing the quality of the valuable dry gels generated by the process are:
Analysis of the relevant metal dopants present in the dry gel in the concentration required, that in cases, is well in excess of 10% by weight of metal;
The Leaching Tests that show practically no metal released by the gel under the specified testing conditions.

Particularly the present invention relates to an improved sol-gel process comprising the following operations:—
a) Preparation of an aqueous or hydroalcoholic solution, or suspension, of at least one compound having the formula

Xₘ-M-(OR)ₙ₋ₘ
Where M is a cat-ion of to the 3^{rd}, 4^{th} and 5^{th} Groups of the Element Periodic System; n is the cat-ion valence, m can be 0, 1 or 2, X is R₁ or OR₁, R and R₁ are hydrocarbon radicals, the same or different, having a carbon atom number from 1 up to 12;
b) optional addition or mixing to the solution of the desired dopants in the form of solutions or as soluble powders containing the desired metal precursors in hydrolysable form, selected from the set of 74 elements of the periodic table identified as all elements of groups IIA, IIIB, including the Lanthanide and the Actinate series IVB, VB, VIIB, VIIB, VIIIB, IB, IIB, continuing with those of group IIIA, with the exception of Boron, to reach Germanium, Tin and Lead in group IVA.
c) Hydrolysis of the above said compound to form the so called sol;
d) Possible addition of the oxide MO_{n/2} under the shape of a suitable morphology fine powder, in which “M” and “n” have the same meaning sub a);
e) Sol gelling;
f) After the aquagel gellation and consolidation, addition of a liquid (i.e. typically water) in a controlled volume (to ensure a suitable external recycle of the aquagel liquid phase);
g) Transfer of the liquid from the gelling mould, or the doping reactor, to an analysis step (to determine the composition and the relevant concentrations);
h) Possible modification of the same concentration determined in the liquid to ensure more suitable conditions for the immobilization of the analysed ionic species in the aquagel (typically cationic);
i) Possible recycle of the liquid to the aquagel (step f)), in the case the composition seems inappropriate to the desired final products;
j) Possible addition of a suitable concentration of an M hydroxylderivate to the medium;
k) Possible addition of an appropriate concentration of suitable derivatives of metals or anionic groups, in order to modify or to complete the formulation, such additions being selected from metal cat-ions of the elements identified in the set of 74 elements described in the step b);
l) Possible repetition of the steps f), g), h), i), j) till the analysis of the aquagel effluent matches the parameters foreseen to obtain a final product having the required characteristics;
m) Possible substitution of the solvent in the gel pores;
n) Gel drying; if under supercritical conditions the dry gel is an aerogel;
o) Possible further treatments of the dried gel.
According to the invention at least one compound having formula

Xₘ-M-(OR)ₙ—ₘ
is added with vigorous mechanical stirring to a solution, or a colloidal suspension of the dopants as defined in step b) where in such dopants solutions, or dispersion the pH conditions for hydrolysis of the M compound and subsequent gellation are already present.
According to the invention in step b) hydrolysis is preceded and accompanied by a specific and vigorous stirring adequate to timely separate the hydrolysis from the gellation.
According to the invention the compound undergoing the hydrolysis preferably is a silicon derivative.
According to the invention the added liquid in a controlled volume, in the step e) is preferably water.
According to the invention the hydrolysis is carried out at a pH ranging between −2 and +1.
According to the invention the Aero-gel is characterized in that all the relevant properties are predetermined and have the best possible values in connection with any possible utilization such as pore volume equal or superior to 6 cc/g, specific surface equal or superior to 1200 m²/g, silanol concentration equal or superior to 6 m.e.q./g, joined with adequate mechanical resistance equal or superior to 5 Newtons/m² to compression and optical properties rare in an amorphous material, like a perfect extinction to polarized light at 90° angular intervals, observable in slides with thickness of the order of few millimetres.
According to the invention the Aero-gel, when constituted by non-doped pure silicon dioxide, is characterized by:
   total pore volume from 2 cc/g to 8 cc/g,
   surface area from 300 to 1300 m²/g,
   hydroxyl concentration from 2 to 11 m.mole/g.
According to the invention, since the same aims to produce optical glasses, the silicic based aquagel composition is modified [step K)] by the addition of Al or La derivatives.
According to the invention a silica glass doped with Aluminium, as demonstrated on Example 7, exibits values of refractive index measured at the Sodium d-line, (587.56 nm.), consistently equal or above the figure of 125% with respect the values of conventional glasses of identical formulation.
The solution or colloidal suspension of the dopant as defined in step B) can be introduced as a modifier of the liquid phase of the aquagel as in step K) and then processed according to step L).
According to the invention the compound used in step a) is a suitable silicon derivative, preferably a silicon alkoxide, and the solution, or suspension, comprises metal salts in the presence of free mineral acids at concentration ≧0.5 mole/l, when applied to the vitrification of liquid nuclear wastes to safety store the same by ensuring a very long period stability thereof.
Further subject of the invention are glasses produced by the vitrification of liquid radioactive wastes containing metals, including radioactive isotopes, as oxides, permanently immobilized in the glass oxide network, which are characterized by the homogeneity of the glass concentration of the metals and, mainly, of the radioactive isotopes.

Further subject of the invention are glasses when obtained by means of the improved sol-gel process according to the invention, when the dried doped gel is either in the form of xero-gel, or of fractured xero-gel, or of fractured aero-gel and a monolithic body is achieved either by compounding it with a conventional glass and melting it in a furnace, or by inglobtaining the doped gel into a low viscosity melt of conventional glass, or by proper inglobation in concrete artefacts in the proper proportion of glass to cement.

The metal precursor undergoing the hydrolysis reaction may be any compound suitable thereto, according to the prior art.

Therefore use can be made of soluble salts such as, for instance, nitrates, chlorides or acetates; furthermore it is possible to use alkoxides or alkoxide mixtures according to the above general formula, and this is the preferred embodiment. Among the others, particulary suitable are the silicon alkoxides such as tetramethoxyorthosilane, tetraethoxyorthosilane and tetrapropoxyorthosilane.

The hydrolysis is carried out in the presence of an acid catalyst, and water can be the solvent or it can be added to an alcoholic solution of the interesting precursor: more about hydrolysis, the conditions and the procedure are the ones described in the prior art such as, for instance, U.S. Pat. No. 5,207,814 according to which the hydrolysis is carried out at the ambient temperature and the preferred acid catalysts can be hydrochloric acid, nitric acid, sulphuric acid or acetic acid. Metal oxides and particularly silicon oxides can be emulsified with the sol prepared thereby to modify the properties according to, for instance, U.S. Pat. No. 5,207,814. The hydrolysis is carried out at the ambient temperature, at a pH value equal to or different from the one characterizing to the subsequent gellation/condensation, ranging from −2 to +1: the choice of the pH value is the task of the skilled man who has to evaluate whether the hydrolysis is to be carried out under conditions close to the gellation ones.

On turn, during the whole hydrolysis process the system is kept under vigorous stirring to carefully control the dispersion in order to prevent the instantaneous gelation of the sol.

In such a way, an aero-gel is obtained having physical and mechanical characteristics never found in the prior art, either by following the conventional way of hydrolysis and gellation distinct pH conditions examples 1÷4, (the stirring purposes to accelerate the hydrolysis by more contacting two immiscible liquids such as, for instance, silicon alkoxide and water), or by following the single “hydrolysis-gelation pH condition according to, for example, the WO 2005/040053. In the latter case the stirring has to be adjusted to avoid the instantaneous condensation of the sol mass. It is surprising by vigorous stirring to obtain timely spaced hydrolysis and gellation, which would otherwise occur simultaneously.

The second process type, i.e. hydrolysis-gellation occurring without pH change, is particularly aimed at producing an aero-gel having physical and chemical characteristics peculiarly corresponding to the present invention target, such as the total volume of the pores and surface areas both at very high values, and more important, the hydroxyl content, specifically silanol, that reaches unusual high values expressed in moles/g of material. When use is made of a chemical modifier in liquid phase of the aquagel, such as a hydroxyl-derivates, a preferred embodiment of the present invention does refer to silicic acid Si(OH)₄: the adding concentration is evaluated by the skilled operator based of the results of the analysis carried out during the monitoring operation of the gelling phase effluent. The analysis of the effluent during the gelling phase aims, as above said, at ascertaining that the chemistry (composition and/or concentration is the one correlating) with the final material wished characteristics, i.e.:
In the liquid phase there are no ionic species supposed to be irreversibly immobilized in the aqua-gel;
The liquid phase stays under such conditions to allow the fixing of the ionic species to the aquagel oxide network, for instance the best value relevant to the pH specific immobilization;
The equilibrium state eventually reached in the immobilization of the questioned metal cat-ions to the hydroxyl groups, specifically silanols, of the aqua-gel oxide network, in order to be able to consider whether to add, or not, further species.

In this connection the skilled people are able to select the most suitable procedure and instrumentation. In order to make a simple exemplification, it is possible to quote:
Control of the hydroxyl content available in the relevant aqua-gel “at start” of the doping process. It is done on aero-gel: a properly dried aero-gel is assumed as relevant model on which to determine experimentally the hydroxyl content. The number of the aero-gel hydroxyl content can be evaluated in moles/g by the gas-volumetric analysis. A second direct method, to be used to check the first one or as an alternative thereof, is the hydroxyl quantitative analysis via NMR. A third direct method is based on the weight loss during a thermal treatment from the environment temperature to 800° C. The aero-gel must be carefully prepared to ensure that the weight loss is due to the only hydroxyl. All organic residues have to be previously removed by a suitable thermo-oxidative treatment, then the aero-gel has to be properly re-hydrated and the chemically adsorbed water is to be removed under vacuum at calibrated temperature with an infrared spectroscopy check. At this point the aero-gel is ready for the hydroxyl thermo-gravimetric analysis.
Determination of the doping agents level, in general terms metal cat-ions irreversibly fixed in the aqua-gel.
A relatively simple procedure starts from the systematic analysis of the recycle liquid exterior to the aquagel mould. The decrease of the interesting doping agent concentration in the solution means a potential immobilization thereof in the aqua-gel. In the next step, the aqua-gel is apparently doped: the recycle liquid phase is drained and substituted by a suitable volume (equal) of bi-distilled water. A first recycle to get the liquid phase back to equilibrium is characterized by a minimum concentration of doping agent, typically equal to or lower than 1%÷2% of the value potentially reachable from the aquagel enrichment. The recycle, prolonged over hundreds of hours too, typically outlines a null increase of the relevant concentration in the liquid phase. The result can be a sufficient proof in order to state that in the aquagel there is a permanent immobilization of all doping agents now missing in the liquid composition (the mass balance).
The conclusive evidence is reached by the analysis (destructive) of the aquagel as far as the specific doping agent. The mass balance quantitatively shows the content of the cations irreversibly linked to the aquagel network.

Also the kind of the doping agent is chosen by the skilled people in connection with the wished final compound. In order to have again a simple example indication, in the case of optical glasses purposed to the refractive optics, it is possible to mention that the beginning silicic base aquagel composition can be modified by Al³⁺, La³⁺ to increase the refraction index thereof; on the other hand, the index can be lowered by F⁻.

The invention, as discussed in the earlier part of this patent application, has a broad utilization in doping glasses, either for the purpose of obtaining innovate optical materials or for secure immobilization in glasses of undesirable components of wastes.

All the metal cat-ions are susceptible to form oxides and to be bonded covalently to a solid network of oxides, particularly silicon oxides, under proper conditions, particularly proper pH and adequate proximity. They might make an exception to this rule only the elements of group IA in the periodic table of the element. The list of the metal cat-ions addressed by the invention starts with those that can be obtained by the elements of group IIA (Be, Mg . . . etc), follow with those from group IIIB, including the lanthanide and actinate series, IVB, VB, VIIB, VIIB, VIIIB, IB, IIB, to continue with those from group IIIA with the exception of Boron, to reach germanium, Tin and Lead in group IVA for a total of 74 elements.

As said, the process according to the present invention allow to obtain final products having predetermined characteristics, these all being at values setting the same among the known most valuable ones in connection with the purposed uses, and these products, thus characterized by such a property whole, are an integral part of the invention and fully belong to the dominating rights pertaining to the present patent application as well as to the future corresponding patents.

The final products, i.e. substantially aero-gels as well as dense glasses obtained by post-treating the same, are characterized by unique properties. For instance, original un-doped aero-gels are characterized by three important structural properties that let the same be unique and classifiable as materials optimized to the specific use. In this connection and hereinafter, there are reported the values relevant to an un-doped aero-gel obtained through the process of the present invention, according to the specification of the following experimental section.

### Pure Silicon Dioxide Undoped Aero-Gel

| | |
|---|---|
| Pore total volume | 6.20 cc/g |
| Surface area | 1250 m²/g |
| Hydroxyl concentration | 10.53 m · mole/g |

The above referred aero-gel owns characteristics already being in the starting aquagel, which are particularly favourable to the Applicant process as described in the present patent applied such as the high hydroxyl content (silanols) which seems to be active in the metal cat-ion immobilization during the recycle step, or the remarkable total porosity which allows the liquid flowing in the same recycle step.

From a general point of view an advantageous embodiment of the inventive process stands when use is made of aqua-gels that, in the non-doped state, give rise to aero-gels having the following characteristics:

| | | |
|---|---|---|
| Pores total volume | ≧2 cc/g | ≦8 cc/g |
| Surface area | ≧300 m²/g | ≦1300 m²/g |
| Hydroxyl concentration | ≧2 m · mole/g | ≦11 m · mole/g |

The non-doped aero-gel can be considered as the referring point in the evaluation of the doped aero-gels, in which the hydroxyl content and, partially, also the micro structural characteristics are modified by the immobilization process of doping agents.

Modifications occurring in the gel by the immobilization process of the metal cat-ions is evidenced by comparison of the characteristic values of an aero-gel after doping process, to the original values of same type of aero-gel before doping (pure silicon dioxide un-doped aero-gel) the analysis by porosimeter is used for the purpose.

Silicon dioxide aero-gel after the process of:

| Immobilization of | 16.5% by weight aluminium |
|---|---|
| Pore total volume | 3.34% |
| Specific surface | 436 |

The same type of aero-gel, Al-doped silica, can be suitably densified [step n) of the inventive process] to form an optical glass having high optical homogeneity, high Abbe number, high chemical stability, and a characteristic whole set of physical properties such to classify the glass as innovative and the relative quality at the highest values according to the commercialization standards. Just to make an example to illustrate an optical glass obtainable through the process post treatments, this one can be as follows:

General formulation SiO₂: Al₂O₃
Molar ratio 6.52:1
Refraction index nd 1.52
Abbe dispersion 77

### Density 2.45

The sol-gel process according the invention aimed to carefully preparing multi-oxide glasses is based on the control and the determination of ionic species, specifically cationic, in the aqua-gel, through the recycle of the relevant liquid phase, suitably monitored and eventually modified. To the purpose, use is made of special aqua-gels characterized in that they can provide exceptional high values of silanol concentration, total pores volume and specific area.

The process is an innovation of sol-gel technology to the extent that it provides systematic immobilization of large quantities of dopants at the molecular level, through chemical—bonding to the oxide network of the gel.

This process opens the door to diversified, far-reaching applications, like more and better optical glasses, as well as to long-range stocking of radioactive nuclear wastes, permanently trapped into special sol-gel glasses.

### EXAMPLES

### Example 1

### Doping at Sol Level (Conventional)

A sol was prepared as follows through an hydrolysis at pH 2 and titration at pH 2.5, 1.60 molar as TEOS, doped with 1.06 molar Al³⁺.

302.2 g of bidistilled water were weighed in a large “duran” glass laboratory cup and 0.3 g HNO₃, 70% conc, was added thereto. A laboratory mechanical stirrer of the type RW20 IKA-WERK was set on the cup with the rotating anchor dipped in the liquid inside the cup. At the starting experiment time (time 0), the mixer was activated at a “1” stirring rate equal to about 250 r/m. The registered liquid temperature was 33° C. After 5 minutes (time 5) 114.1 g of Al(HO₃)₃9H₂o were added to the liquid: the stirring rate was increased to level “2” corresponding to about 500 r/m. The registered liquid temperature was 32° C. At time 10, the doping agent addition was completed, the temperature was 25° C., the stirring at “1.5” rate. At time 40, and a temperature of 25° C., 101.1 g TEOS were started to be added through a dipping funnel, the stirring rate being increased to “2”.
Time 45: end of TEOS addition, temperature of 27° C., stirring rate kept at level 2.
Time 60: temperature of 27° C., ultrasound gas removal.
Time 75: temperature of 52° C., degasage end, cup into an ice bath.
Time 110: temperature of 21° C., pH 1, titration start with 1.52 molar NH₃.
Time 115: pH 2.51, sol gelification. Total volume of added NH₃ of 175 ml.

The aquagel was covered with 100 ml bidistilled water and hermetically sealed in the container. After 48 hours, the volume of the upper water was replaced by an equal volume of bidistilled water and analysed. The aluminium content present in the first washing water, (100 ml) measured at ICP, was equal to 29.6% on the total of the sol.

This example 1 shows that a substantial amount of the doping agent contained in the starting sol and gelled through a conventional process, according to U.S. Pat. No. 5,207,814, was lost from the aquagel by the first washing water.

### Example 2

### Doping at Sol Level (Single pH Condition)

A sol was prepared in HNO₃ 1 molar, 1.60 TEOS, 1.06 molar Al³⁺ doped, hydrolysis and gelification, according to the following:

273.8 g of bidistilled water were weighed in a “Duran” glass laboratory cup; 29.4 g of HNO₃, 70% by weight, were added thereto. A mechanical stirrer of the laboratory type RW20 IKA-WERK was set on the cup with the stirring anchor into the liquid contained in the cup. At the experiment beginning (time 0), the mixer was set at a rate “1” equal to 250 rpm. The liquid temperature was registered at 36° C. After 5 minutes (time 5) 114.4 g of Al(HO₃)₃9H₂O were started to be added, the mixer being at a rate 3.
Time 20: temperature at 27° C., the doping agent addition was completed. A suitable container with melting ice positioned around the cup.
Time 125: temperature at 12° C., 100 g TEOS were started to be added through a dipping funnel, mixer rate at “4”.
Time 130: temperature at 19° C., TEOS addition was completed and the mixer speed “4” was maintained.
Time 140: rate “0” (off), the cup was set under degasification by ultrasounds, and the cup was cooled into an ice bath.
Time 155: sol was completed and poured into a cylindric mould. The gelification occurred about over 15-17 hours. The aquagel was covered by 100 ml bidistilled water and sealed. After 48 hours the volume of the part of the water was replaced by an equal volume of bidistilled water and analyzed.

The Aluminium content present in the first washing water, at ICP measurement, was equal to 37.3% with respect to the total in the sol.

The example 2 shows that a substantial amount of the doping agent contained in the starting sol and gelled through a single pH condition hydrolysis gelification” process according to the WO 2005/040053 was lost from the aquagel by the first washing water.

### Example 3

### Doping at Sol Level with a Recycle Procedure

A sol was prepared in HNO₃ 1 M, 160 molar TEOS and doped with 1.06 molar Al³⁺, according to the same method reported in the example 2. Once the sol was completed, two 90 mm diameter cylinder moulds were filled and sealed.

The gelling process occurred over 15 hours. After gelification, the two aquagels with the washing water were transferred into a column set to be an aquagel doping reactor, according to FIG. 1. The column liquid was increased to a 1000 ml total volume by the addition of bidistilled water. The recycle pump engine was activated at “zero” time and the liquid recycled through the aquagel was monitored in function of time as to the pH values and to the Al concentration, in whatsoever form in the solution. The liquid phase monitoring was carried on by a periodic sampling through a suitable drawing point, as from FIG. 1. After pH measurement, the sampled liquid was again fed to the recycle through the same valve, but a low fraction retained for analysis via electrochemical methods Al determination, i.e. through a destructive analysis (DL-50, Mettler Toledo).

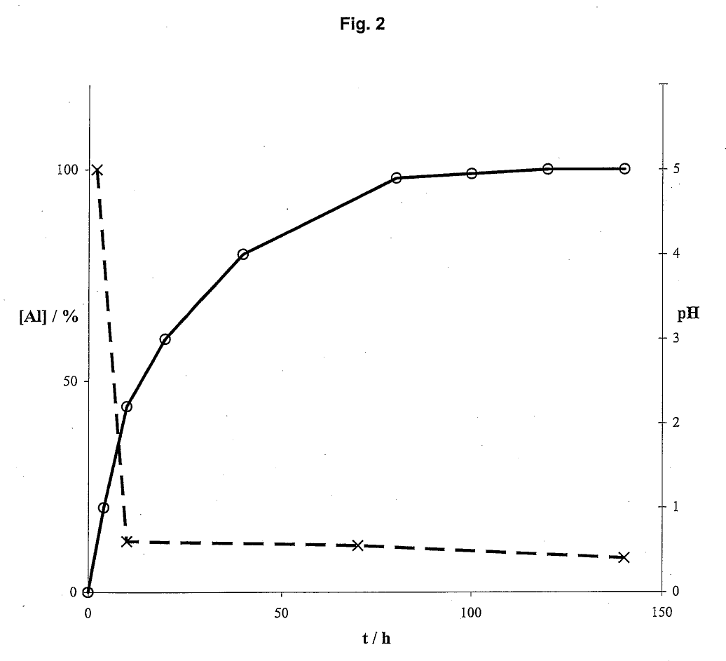

The collected data are illustrated in FIG. 2, in which the pH values are in the right scale and the Al connected values on the total weight percentage in the left scale: both amounts are plotted against time, in hours, reported in abscissas.

The FIG. 2 data outline that starting nitric acid (dotted line) and aluminium nitrats (continuous line), at the beginning wholly contained in the aerogel, diffused from the aquagel to recycle liquid phase and in absence of any perturbation touch the balance over 80-100 hours. Once the balance was achieved, aluminium in the recycle liquid phase touch a concentration equal to 88% of the highest possible values. The datum means that, under the example 3 experimental conditions, there apparently are a 12% maximum of Al³⁺ immobilized in the aquagel and 88% Al³⁺ free in solution.

The example 3 confirmed the data already known from the two previous examples: i.e. the sol doping agent is not necessarily immobilized in the consequent aquagel, but it leans to diffuse into the washing water.

### Example 4

### Doping at the Aquagel Level with a Recycle Procedure According to the Present Invention

The conditions were the same set in example 3.

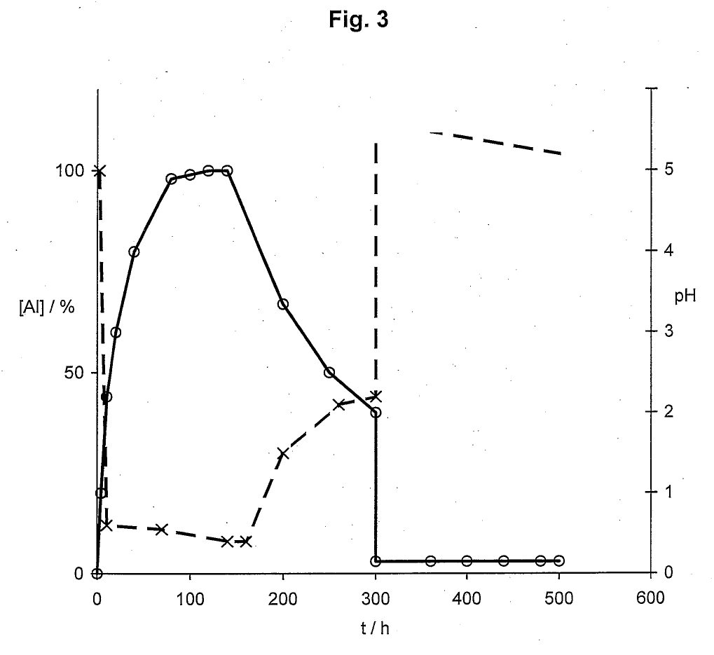

One the equilibrium was obtained during the recycling, one of the fundamental parameter has been changed in the recycled liquid: in the present case it was pH. Through the inlet 7, at time 160 hours, concentrated ammonia was added to increase the pH value in the aquagel liquid phase. Slowly add ammonia, 70 cc (30% NH₃), corresponding to 1.099 moles. The pH change caused, at the equilibrium, substantial modification of Al³⁺ concentration in the liquid phase. The collected data are reparted in the FIG. 3 wherein, in the right ordinate there is the pH value, and Al³⁺ concentration by wt % is in the left scale both amounts are plotted against time, as hours, reported in abscissae. The continuous line graph refers to [Al], the dotted one refers to pH.

After the interruption of the experiment of recycling driven doping, the aquagels was processed till to glasses according to the standard procedures, i.e. through the solvent exchange, supercritic drying and oven densification. An aerogel was utilized on an elementary analysis (destructive) to determine the present aluminium; the other aerogels were densified to glass, thereby a relatively dense glass was obtained (2.45 density in comparison with the silicon glass density of 2.20) having a refraction index of 1.52.

The FIG. 3 data outline that:
aluminium in the recycle liquid phase solution substantially decreases after the ammonia addition (pH modification);
the washing of the doped aquagel by bidistilled water, prolonged over further 200 hours, does not provoke any increase of the aluminium concentration in the recycle liquid phase:

ΔAl=[Al]₅₀₀−[AL]₃₀₀=0;
apparently, at the experiment stop, a substantial fraction of the starting aluminium, equal to 60%, was missing from the liquid phase solution and did not come back to solution after further 200 hour washing the aquagel by bidistilled water. The proof that the aluminium amount lacking in the liquid phase was truly immobilized in the aquagel was obtained by the elementary analysis of the aerogel obtained by processing the aquagel. The results of the relevant analysis are in Table 1.

TABLE 1
Al concentrations in recycle liquids

| | | |
|---|---|---|
| uniform theoretical in the global volume (Vl + Vg) | 7850 | ppm |
| in the starting recycle liquid (Vl) | 0 | ppm |
| in the equilibrium recycle liquid (Vl) | 7100 | ppm |
| new balance after NH₃ addition (Vl) | 2658 | ppm |
| lacking Al in Vl at the equilibrium after NH₃ | 4442 | ppm |
| in the fresh washing liquid | 392 | ppm |
| in the washing liquid after 200 hours | 426 | ppm |
| in aerogel | 10.9% | wt |
| in aerogel (corresponding to ppm in Vl) | 6160.6 | ppm |
| in glass | 11.3% | wt |
| in glass (corresponding to ppm in Vl) | 4313.1 | ppm |

(Vl = recycle liquid volume; Vg = aquagel volume)

The data collected in the Table 1 mean that the model cation (Al³⁺) has, under the process conditions, migrated from the recycle liquid (7100 ppm at the starting balance) to the aquagel: 4442 ppm of Al lacking from solution after the NH₃ addition which match the 4160.6 ppm of Al measured in the aquagel, or the 4313 ppm of Al measured in the glass corresponding with.

### Example 5

### Difference Between Aquagels Obtained by Doping at Sol Level or at Aquagel Level, Respectively

A remarkable structural difference among doped aquagels can be outlined by letting the gel undergo an evaporation process under atmospheric pressure. The atmospheric evaporation process is well known to the skilled people in order to produce the so called “xerogel”. The xerogel, a gel dried under atmospheric pressure, can be economically attractive when the general conditions allow the preparation thereof and only in the case of those applications compatible with the many limitations of the very preparation process. In the specific case of aquagels strongly doped by metal nitrates, the atmospheric pressure evaporation process can outline a remarkable difference between sol level formulated samples and aquagel level formulated samples by the liquid phase recycle method according to the Applicant present invention.

The experiment consisted in atmospheric pressure evaporation drying two doped aquagels: one prepared by the conventional method and the other one prepared by the recycle method. The formulation of the conventional sample (sample 1) was the one described in the example 1; the sample doped by the recycle method (sample 2) had the formulation of the example 4. Under the same evaporation conditions, there was no possibility to evaporate sample 1 under the atmospheric pressure since the contained doping agents, coming out from the aquagel body formed a very large inflorescence body having large sizes with respect to the starting gel. On the contrary the sample 2, doped at the aquagel level according to the Applicant process, could be dried up to a good quality glass, as judjed by visual inspection and, above all, without any inflorescence trace.

### Example 6

### Vitrification of an Acid Salty Solution

The formulation of high radioactivity liquid nuclear wastes is very wide, depending on the same nuclear place or on the industrial process treatment undergone in the preceding stabilization path:

However some general characteristics are common to all high radioactivity nuclear wastes, and these are:
The presence of free mineral acid at about 1 mole/l concentration prevalently nitric acid;
The presence of metal cations at relatively high concentration: typically about 2% by weight;
The stabilization of the metal cations in inorganic salts, typically nitrates at a salty concentration of about 9% by weight;
The presence of radioactive isotopes, generally nuclear fission products, at very low concentrations, radioactivity corresponding to a plutonium concentration of 5-10 ppm. The many supranational or national programs for the definitive stabilization and the very long term storing of this waste kind, are based on the vetrification. Herein a salty solution in nitric acid was treated to simulate a high radioactivity liquid nuclear waste;
Liquid mineral acid is 1 molar HNO₃;
Metal cations at 2% b.w. concentration consisting of aluminium nitrates;
Salts concentration of 28% b.w. constituted by aluminium nitrate;
Radioactive isotope traces, chemically sumulated by Ce³⁻ and Nd³⁺
   under nitrate shape, at a concentration of 10 ppm. respectively.

A solution was prepared having the previously described general characteristics of a high radioactivity liquid nuclear waste: 275 g of bidistillated water were added by 30 g HNO₃ 70% b.w., in a suitable Duran glass reactor equipped with an adequate mechanical mixer. The mixer was activated in advance and at an adequate intensity, before the addition of doping and chelating agents. Slowly the following substances were added, in the order: 115 g Al (HO₃)₃9H₂O, 9.68 mg Ce(NO₃)₃6H₂O and 9.40 mg Nd (NO₃)₃6H₂O.

The prepared solution reproduced the chemical general characteristics of a liquid nuclear waste, with the simulation of 20 ppm. radioactive isotopes represented by Ce³⁺ and Nd³⁺ added as nitrate salts, adequately reproducing the chemical affinity, according to the literature (T. Woignies and others, Proc. Int. Congr. Class, Vol. 2 Extended Abstract, Edinburgh, 1-6 Jul. 2001, pp. 13-14).

The solution formulation was the following:

| | | | |
|---|---|---|---|
| HNO₃ | 0.344 | mole/l | 94340 ppm |
| AL³⁺ | 0.312 | mole/l | 43082 ppm |
| Ce³⁺ | 0.0713 × 10⁻³ | mole/l | 10 ppm |
| Nd³⁺ | 0.0693 × 10⁻³ | mole/l | 10 ppm |

The solution was gelled as follows:

the liquid temperature was set to 10° C. by melting ice on the reactor external. The rate of the glass stirrer/homogenizer was suitably increased and the addition of 100 g tetraethoxysilane (TEOS) was added by a dipping funnel. The total time of the sol preparation from the ready solution was lower than 30 minutes.

Once TEOS addition was completed, a clear liquid was obtained, apparently monophased. The gas was properly eliminated from the liquid (sol) via ultrasounds treatment over 10 minutes and then poured into polycarbonate cylindrical moulds, equipped with hermetic sealing.

The sample gelation occurred over 15 hours; the aquagels, three (3), were each one covered by 100 cc bidistilled water. After 48 hours all three aquagels were transferred into a recycling reactor, according to the present invention previous description. The recycle process was completed by the gradual addition of 90 ml NH₃ at 30%. The recycle procedure was analytically followed according to the example 3 description.

The analytical data were generated by an ICP-Mass monitoring the evolution of the Ce and Nd concentrations. The experiment was carried out till the Aluminium concentration reduction in the liquid phase from 7300 ppm to 310 ppm. The Ce and Nd concentrations reduced under the device detection level.

After the recycling phase, the aquagels underwent the solvent exchange, supercritic drying and glass densification. Very compact glasses were obtained normal at the eye inspection, having a density of 2.481 g/cm³.

The example 6 clearly shows that the technology, developed to dope silica glasses with substantial metal ion concentrations permanently immobilized in the glass oxide network, can be applied to the vitrification and the safety store of liquid nuclear wastes.

### Example 7

### New Material Synthesized with the Procedures of the Invention

The experiment was conducted as in example 4.

A glass containing 11.3% Al by weight was obtained.

The formulation of the glass at 587.56 mm. was measured accurately and resulted 1.52.

The Abbe dispersion number was determined 77.

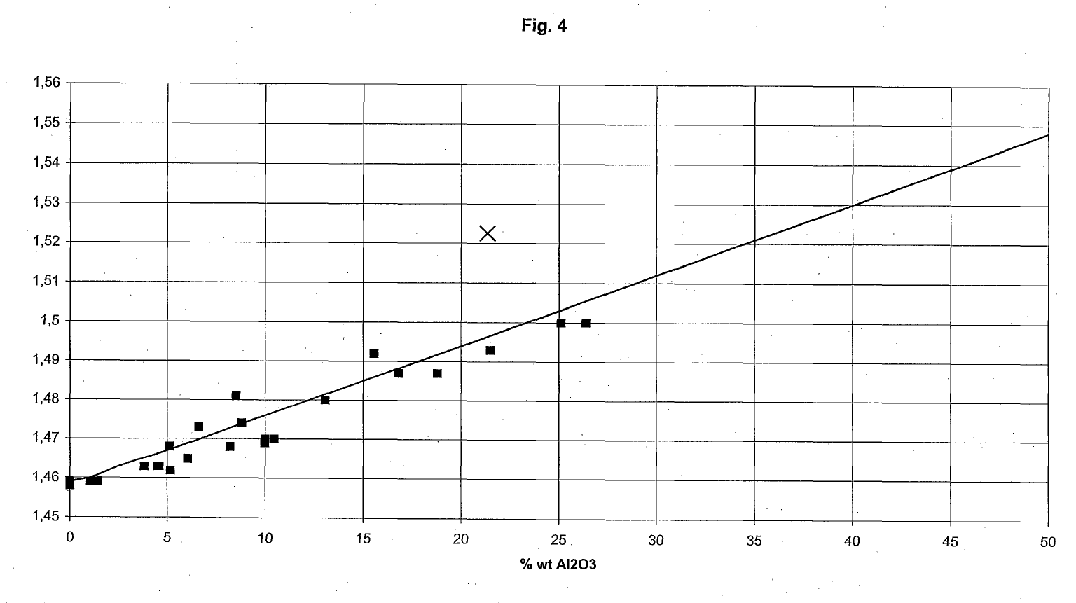

The density of the glass accurately measured was 2.45. The above physical properties measured in the glass produced in example 7 were compared to the properties of commercial and/or experimental glasses reported by the pertinent literature. The comparison for the relevant refractive index values is done in FIG. 4, that represents on the ordinate axis refractive indices at λ=587.56 mm. and on the abscissa concentrations of Al₂O₃ in percent weight. Individual values are indicated by red dots. The value of the glass described in the example 7 is superimposed to the diagram and is indicate by a dark cross.

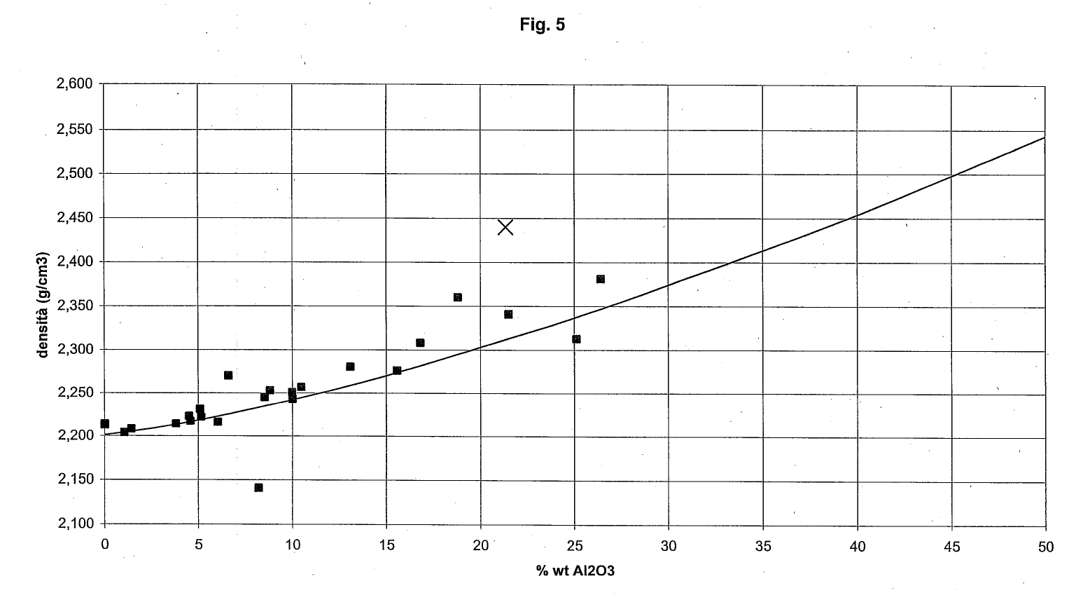

It is clear from the data reported in FIG. 4, that the glass described in example 7 of the current invention, has a value of refractive index substantially higher than any glass of same composition reported in the pertinent literature of FIG. 4. The comparison for the relevant values of material density is done in FIG. 5 in a similar way: Relevant density values are on the ordinate axis and concentration of Al₂O₃ in percent weight are on Abscissa. The density value of the glass described in example 7 is superimposed to the diagram and is indicated as a dark cross. It is clear from the data reported in FIG. 4 and in FIG. 5, that the glass described in example 7 of the current invention, has relevant physical properties, experimentally measured, substantially different from reported glasses of identical formulation. It is reasonable to conclude that the glass produced with process described in example 7 constitute a novel form of aggregation of matter.

FIG. 3

| t/h | [Al] % | t/h | pH |
|---|---|---|---|
| 0 | 0 | 2 | 5 |
| 4 | 20 | 10 | 0.6 |
| 10 | 44 | 70 | 0.55 |
| 20 | 60 | 140 | 0.4 |
| 40 | 80 | 160 | 0.4 |
| 80 | 98 | 200 | 1.5 |
| 100 | 99 | 260 | 2.1 |
| 120 | 100 | 300 | 2.2 |
| 140 | 100 | 300 | 5.6 |
| 200 | 67 | 500 | 5.2 |
| 250 | 50 | | |
| 300 | 40 | | |
| 300 | 3 | | |
| 360 | 3 | | |
| 400 | 3 | | |
| 440 | 3 | | |
| 480 | 3 | | |
| 500 | 3 | | |

FIGS. 4 and 5

| | | | | | | Density at | |
|---|---|---|---|---|---|---|---|
| Code | Glass | Author | Year | Al₂O₃ | SiO₂ | 20° C., g/cm³ | n_{d} at 20° C. |
| 340 | 21455 | Astakhova V. V. | 1983 | 8.199127 | 91.80087 | 2.141 | 1.468 |
| 1979 | 9059 | Namikawa H. | 1982 | 0 | 99.27631 | 2.214 | 1.458 |
| 1979 | 9060 | Namikawa H. | 1982 | 0 | 99.16574 | 2.213 | 1.459 |
| 2038 | 5318 | Nassau K. | 1975 | 1.417159 | 98.58284 | 2.208 | 1.459 |
| 2038 | 5320 | Nassau K. | 1975 | 4.497192 | 95.50281 | 2.223 | 1.463 |
| 2038 | 5321 | Nassau K. | 1975 | 4.578907 | 95.4211 | 2.217 | 1.463 |
| 2038 | 5322 | Nassau K. | 1975 | 9.976205 | 90.0238 | 2.251 | 1.469 |
| 2038 | 5323 | Nassau K. | 1975 | 10.45904 | 89.54096 | 2.257 | 1.47 |
| 3160 | 1499 | Thompson C. L. | 1937 | 5.08982 | 94.91018 | 2.231 | 1.468 |
| 3160 | 1500 | Thompson C. L. | 1937 | 8.8 | 91.2 | 2.253 | 1.474 |
| 3160 | 1501 | Thompson C. L. | 1937 | 13.07385 | 86.92615 | 2.28 | 1.48 |
| 3160 | 1502 | Thompson C. L. | 1937 | 16.8 | 83.2 | 2.308 | 1.487 |
| 3160 | 1507 | Thompson C. L. | 1937 | 21.5 | 78.5 | 2.341 | 1.493 |
| 3160 | 1400 | Thompson C. L. | 1937 | 26.4 | 73.6 | 2.381 | 1.5 |
| 6626 | 38647 | Gan Fuxi | 1959 | 6.603778 | 93.39622 | 2.27 | 1.473 |
| 6626 | 38649 | Gan Fuxi | 1959 | 18.79196 | 81.20805 | 2.36 | 1.487 |
| 10972 | 44449 | Demskaya E. L. | 1983 | 1.047595 | 98.95241 | 2.204 | 1.459 |
| 10972 | 44451 | Demskaya E. L. | 1983 | 3.808572 | 96.19143 | 2.214 | 1.463 |
| 10972 | 44452 | Demskaya E. L. | 1983 | 5.149352 | 94.85065 | 2.222 | 1.462 |
| 10972 | 44453 | Demskaya E. L. | 1983 | 6.024143 | 93.97586 | 2.216 | 1.465 |
| 10972 | 44454 | Demskaya E. L. | 1983 | 9.991811 | 90.00819 | 2.243 | 1.47 |
| 24078 | 179603 | Yagi T. | 2001 | 15.56704 | 84.43296 | 2.276 | 1.492 |
| 24078 | 179604 | Yagi T. | 2001 | 25.11212 | 74.88788 | 2.313 | 1.5 |
| 24078 | 179602 | Yagi T. | 2001 | 8.51562 | 91.48438 | 2.245 | 1.481 |

| | | | | | | |
|---|---|---|---|---|---|---|
| Example 7 | PCT/APPLICATION | 2006 | 21.34 | 78.66 | 2.44 | 1.5226 |

1. Sol-gel process comprising the following operations:
a) preparing an aqueous or hydro-alcoholic solution as suspension of at least one compound having the formula
Xₘ-M-(OR)ₙ₋ₘ
where M is a cation selected from a member of the 3^{rd}, 4^{th} and 5^{th} Groups of the Element Periodic System of Elements, n is the cation valence; m is 0, 1 or 2, X is R₁ or OR₁; R and R₁ are the same or different hydrocarbon having a carbon atom number of 1 to 12;
b) optionally adding or mixing to the solution of a desired dopant in the form of a solution or as a soluble powder containing a desired metal precursor in hydrolysable form, selected from the set of 74 elements of the Periodic Table identified as all elements of Groups IIA, IIIB, including the Lanthanide and the Actinate series IVB, VB, VIIB, VIIB, VIIIB, IB, IIB, including IIIA, with the exception of Boron, and including Germanium, Tin and Lead in group IVA.
c) hydrolyzing of said compound to form a sol;
d) optionally adding an oxide MO_{n/2} in the shape of a suitable morphology fine powder, in which M and n have the same meaning as in a);
e) gelling the sol to form an aquagel;
f) after forming the aquagel appropriate gellation and consolidation, adding a liquid in a controlled volume;
g) transferring of liquid from a gelling mould to an analysis step;
h) optionally modifying a concentration determined in the liquid to ensure a more suitable condition for the immobilization of relevant ionic species in the aquagel;
i) optionally recycling of the liquid to the aquagel;
j) optionally adding a suitable concentration of an M hydroxyl-derivative to medium;
k) optionally adding an appropriate concentration of a suitable derivative of a metal or anionic group in order to modify or to complete the formulation, such additions being selected from metal cations of the elements identified in the set of 74 elements described in the step b);
l) optionally repetition of the steps g), h), i), j), k) until the analysis of aquagel effluent matches desired parameters foreseen to obtain a final product having required characteristics;
m) optionally substituting solvent in the gel pores; and
n) drying the gel.

2. Sol-gel process according to claim 1, where at least one compound having the formula
Xₘ-M-(OR)ₙ—ₘ
is added with vigorous mechanical stirring to a solution, or a colloidal suspension of a dopant as defined in step b) wherein such dopant solution, or dispersion the pH conditions for hydrolysis of the compound and subsequent gellation are already present.

3. Sol-gel process according claim 1, in which in the step b) hydrolysis is preceded and accompanied by a specific and vigorous stirring adequate to timely separate the hydrolysis hydrolyzing from gellation.

4. Sol-gel process according to claim 1, in which the compound undergoing hydrolysis is a silicon derivative.

5. Sol-gel process according to claim 1, in which the added liquid in a controlled volume, in the step f) is water.

6. Sol-gel process according to claim 1, in which hydrolysis is carried out at a pH ranging between −2 and +1.

7. Sol-gel process according to claim 1 in which, a silicic based aquagel composition is modified in step k) by addition of Al or La derivatives to produce an optical glass.

8. Sol-gel process according to claim 1, in which a solution or colloidal suspension of the dopant, as defined in step b is introduced as a modifier of a liquid phase of the aquagel in step k) and processed according to step l).

9. Sol-gel process according to claim 1, in which the compound used in step a) is a suitable silicon derivative, and the solution, or suspension, comprises a metal salt in the presence of a free mineral acid at concentration ≧0.5 mole/l.

10. Aero-gel characterized in that all the relevant properties are predetermined and have the best possible values in connection with any possible utilization including a pore volume equal or greater than 6 cc/g, specific surface area equal or greater than 1200 m²/g, silanol concentration equal or greater than 6 m.e.q./g, and mechanical resistance equal or greater than 5 Newtons/m² to compression and the optical property of a perfect extinction to polarized light at 90° angular intervals, observable in slides with thickness of the order of few millimetres.

11. Aero-gel according to claim 10 and, when constituted by non-doped pure silicon dioxide, is characterized by:
total pore volume from 2 cc/g to 8 cc/g,
surface area from 300 to 1300 m²/g,
hydroxyl concentration from 2 to 11 m.mole/g.

12. A silica glass doped with aluminum exhibiting a value of refractive index measured at the Sodium d-line, (587.56 nm.), consistently equal to or above 125% with respect the values of conventional glasses of identical formulation.

13. A glass according to claim 12 produced by the vitrification of liquid radioactive wastes containing metals, including radioactive isotopes, as oxides, permanently immobilized in the glass oxide network, characterized by the homogeneity of the glass concentration of the metals and, mainly, of the radioactive isotopes.

14. A glass obtained by the sol-gel process according to claim 1, when the gel is dried and doped and is either in the form of xero-gel, or of fractured xero-gel, or of fractured aero-gel and wherein a monolithic body is achieved either by compounding it with a conventional glass and melting it in a furnace, or by inglobating doped gel into a low viscosity melt of conventional glass, or by proper inglobation in concrete artefacts in the proper proportion of glass to cement.
